(19) United States
(12) Patent Application Publication
(10) Pub. No.: US 2007/0248034 A1
(43) Pub. Date: Oct. 25, 2007

(54) METHOD FOR CONTROLLING A STATION AND STATION USING THE SAME

(75) Inventors: Hong-Kai Hsu, Taipei Hsien (TW); Chih-hao Yeh, Taipei County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK INC., Hsin-Chu (TW)

(21) Appl. No.: 11/534,844

(22) Filed: Sep. 25, 2006

Related U.S. Application Data
(60) Provisional application No. 60/745,527, filed on Apr. 25, 2006.

(51) Int. Cl. H04B 7/185

(52) U.S. Cl. 370/318

(57) ABSTRACT

A station connecting to an access point of a wireless local area network (WLAN) is disclosed. A radio frequency (RF) module demodulates received radio signals into baseband signals. A baseband module, coupled to the RF module, converts the baseband signals to a bit stream. A media access control (MAC) module, coupled to the baseband module, processes the bit stream to obtain data packets. An application specific integrated circuit (ASIC), coupled to the baseband module, and MAC module, causes the station to enter a sleep mode, wakes up at least one of the components of the station at a preset original wake-up time to receive a beacon frame from the access point, parses the beacon frame to extract traffic indication map (TIM) information specified therein, and determines a next wake-up time by adjusting the original wake-up time according to the TIM information.

### CROSS REFERENCE TO RELATED APPLICATIONS

This application claims priority of U.S. Provisional Patent Application Ser. No. 60/745,527, filed Apr. 25, 2006, entitled WIRELESS LAN POWER SAVING. In addition, reference is hereby made to the following co-pending and commonly assigned U.S. patent applications: Power Saving Method for WLAN Station, Ser. No. 11/294,788, filed Dec. 6, 2005. The contents of the provisional application and the co-pending application are hereby incorporated by reference.

### BACKGROUND

The invention relates to a wireless local area network (WLAN), and more particularly, to a power saving method for a station in the WLAN.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

According to IEEE 802.11, it is well-defined that beacon frames are sent by an access point (AP) to synchronize a wireless network. The AP shall transmit a TIM with every beacon, and for every DTIM period, a TIM of type “DTIM” is transmitted within a beacon. When the access point buffers broadcast or multicast frames, it shall transmit these buffered frames in DTIM. Thus stations needs to wakeup to receive the broadcast and multicast messages in DTIM. To inform associated stations how many beacon intervals before the next DTIM, each beacon carries a DTIM count value.

According to a conventional method, synchronization between an access point and associated stations cannot be achieved under some circumstances. For example, when an access point changes the DTIM count arbitrarily, the DTIM count expected by the station is different from the DTIM count maintained by the access point. The time at which the station wakes up is different from the beacon frame with DTIM information's arrival time. The station, therefore, cannot receive the beacon frame with DTIM information. In addition, if a station wakes up when the DTIM count is not zero, the station must remain awake until the DTIM period arrives. The awake period consumes energy.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of controlling a station is provided, wherein the station is associated to an access point of a wireless local area network (WLAN). The station enters a sleep mode, which is the doze state mentioned IEEE 802.11. An original wake-up time for the station operating in the sleep mode is determined. At least one of components of the station wakes up at the original wake-up time to receive a beacon frame from the access point. The beacon frame is parsed to extract traffic indication map (TIM) information specified therein. A next wake-up time is determined by adjusting the original wake-up time according to the TIM information.

A method of controlling a station is provided, wherein the station is connected to an access point of a wireless local area network (WLAN). The method is implemented by an application specific integrated circuit (ASIC) in the station. The station enters a sleep mode. An original wake-up time for the station operating in the sleep mode is determined. At least one of components of the station wakes up at the original wake-up time to receive a beacon frame from the access point. The beacon frame is parsed to extract traffic indication map (TIM) information specified therein. A next wake-up time is determined by adjusting the original wake-up time according to the TIM information.

A station is provided, connecting to an access point of a wireless local area network (WLAN). A communication unit receives beacon frames from the access point. A beacon parser parses the beacon frames to extract traffic indication map (TIM) information specified therein. A processing unit determines, according to the TIM information, a next wake-up time by adjusting a preset original wake-up time for the station operating in the sleep mode.

A station is provided, connecting to an access point of a wireless local area network (WLAN). A radio frequency (RF) module demodulates received radio signals into baseband signals. A baseband module, coupled to the RF module, converts the baseband signals to a bit stream. A media access control (MAC) module, coupled to the baseband module, processes the bit stream to obtain data packets. An application specific integrated circuit (ASIC), coupled to the baseband module, and MAC module, causes the station to enter a sleep mode, wakes up at least one component of the station at a preset original wake-up time to receive a beacon frame from the access point, parses the beacon frame to extract traffic indication map (TIM) information specified therein, and determines a next wake-up time by adjusting the original wake-up time according to the TIM information.

### BRIEF DESCRIPTION OF DRAWINGS

The invention can be more fully understood by reading the subsequent detailed description and examples with references made to the accompanying drawings, wherein:

FIG. 1 shows a schematic view of operation of a power saving mode according to 802.11 WLAN;

FIG. 2 shows a format of a TIM element;

FIGS. 3˜5 illustrates a schematic diagram of a first embodiment of station; and

FIG. 6 is a flowchart of an embodiment of a call processing method.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

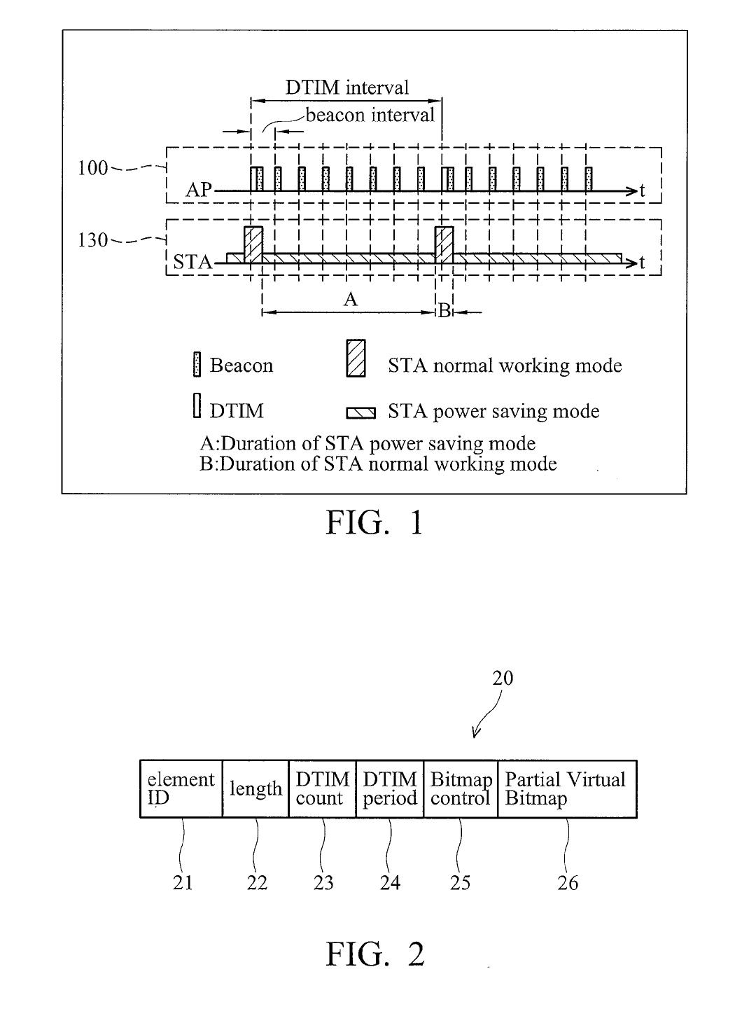

The invention is now described with reference to FIGS. 1 through 6, which generally relate to operation of a station in a wireless local area network (WLAN). In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

The invention can be implemented in a station connected to a wireless local area network operating according to the IEEE 802.11 standard.

Since the primary purpose of a WLAN is to provide service for mobile nodes, which typically rely on battery power, efficient utilization of transmission and reception power is an important consideration. The IEEE 802.11 standard specifies an optional power saving mode for stations. The stations operating in the power saving mode listen to beacon frames periodically broadcast from the access point.

FIG. 1 shows a schematic view of the operation of a power saving mode according to IEEE 802.11. Block 100 depicts activities in an access point. The access point generates beacon frames periodically. A time interval between two beacon frames is referred to as a “beacon interval”.

Each of the beacon frames contains a TIM (traffic indication map) along with other information. For every DTIM period times of beacon interval, a DTIM is transmitted other than usual TIM. Generally, a DTIM count value is contained in each beacon frames and indicates the number of beacon interval before the next DTIM. Each beacon frame also contains a valid time stamp. The associated stations use the time stamp to synchronize their own local time with the AP.

Block 130 depicts activities of a station associated with the access point. It is well known that the station will consume far less power during sleep (power saving mode in block 130) by shutting off nearly every component of the station except a timing circuit. This enables the station to continue its function with very little power consumption as long as it wakes up periodically (at the right time, which is depicted in the block 130 as a “normal working mode”) to receive regular beacon frames coming from the access point.

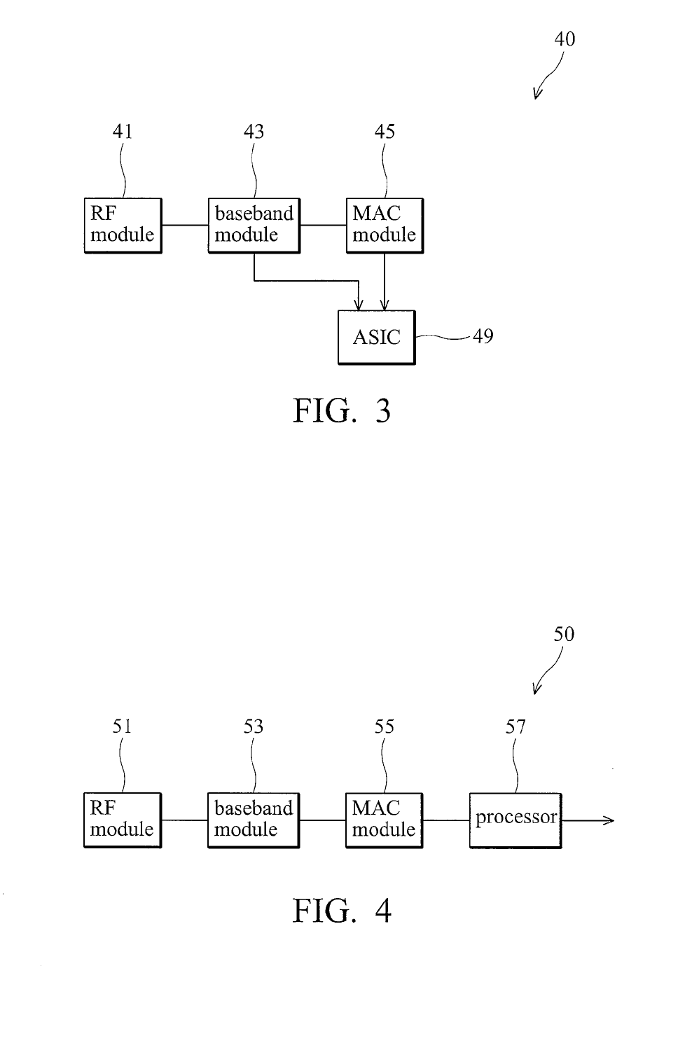

FIG. 2 shows a format of a TIM element 20. Stations that currently have frames buffered in the access point are identified in the TIM element 20, which is comprised as an element within all beacon frames generated by the access point. The TIM element 20 comprises: element ID 21, length 22, DTIM count 23, DTIM period 24, Bitmap control 25, and Partial Virtual Bitmap 26. The element ID 21 identifies the TIM information element. The DTIM count 23 specifies the number of beacon frames to the next DTIM. When the DTIM count 23 is zero, it indicates that the current TIM is a Delivery TIM (DTIM). The DTIM is used for delivery of broadcasts or multicast frames, wherein the DTIM interval is one or more beacon interval.

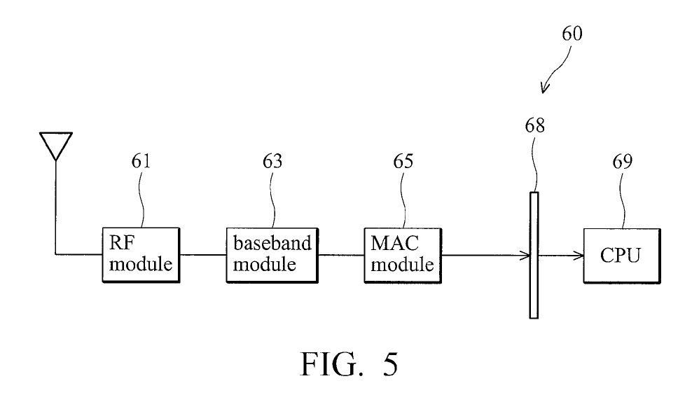

FIG. 3 illustrates a schematic diagram of a first embodiment of a station. The station 40 comprises a radio frequency (RF) module 41, a baseband module 43, a media access control (MAC) module 45, a processor 47, and an application specific integrated circuit (ASIC) 49. The RF module 41 demodulates received radio signals to generate baseband signals. The baseband module 43, coupled to the RF module 41, converts the baseband signals to a bit stream. The MAC module 45, coupled to the baseband module 43, processes the bit stream to obtain data packets. The ASIC 49 is provided to perform the power saving mode operation. When the station 40 enters a power saving mode, beacon frames received by the station 40 are parsed by ASIC 49.

For example, according to the power saving mode specified in the IEEE 802.11 standard, the station informs the access point it's going to enter power saving mode by transmitting a frame with power saving bit on. In power saving mode, the station can switch its state between doze state and awake state. In doze state, the station can shutdown its RF module 41, baseband module 43, MAC module 45 to reduce power consumption. Meanwhile, the ASIC 49 would switch to a slow clock to continue time calculation. The ASIC 49 is dedicated to implementing a power saving mode, such as beacon frame parsing. The access point buffers directed frames toward a station in power saving mode and only transmits broadcast and multicast frames in DTIM. The periodically transmitted beacon frame's TIM field indicates whether there are queued packets for a particular station. At expected beacon's arrival time, the ASIC 49 wakes the RF module 41, baseband module 43, and MAC module 45 to receive a beacon frame, and parses the beacon frame for further operation, such as generation of interrupts or dropping such frames. The ASIC 49 determines whether the DTIM count in the received beacon is 0. If the DTIM count is not 0, the subsequent wake-up time is adjusted according to the DTIM count. Generally, the next time the ASIC 49 wakes up is when a beacon frame specifying a DTIM count 0 arrives.

The TIM field in a beacon frame indicates whether buffered unicast or broadcast/multicast exists. The station 40 may transmit a PS-Poll frame to the access point to request the unicast packets. The broadcast/multicast packets are transmitted following the beacon with DTIM count equals 0, and if the station wishes to receive buffered broadcast/multicast frames, it shall wake up in DTIM. In some cases, the ASIC 49 also provides a matching mechanism that further determines whether a broadcast/multicast packet to be received, such that only necessary packets are received and unnecessary packets discarded, with receiving operations performed by the processor 47 are reduced.

FIG. 4 illustrates a schematic diagram of a second embodiment of a station. A station 50 comprises a radio frequency (RF) module 51, a baseband module 53, a media access control (MAC) module 55, and a processor 57. The RF module 51 demodulates received radio signals to generate baseband signals. The baseband module 53, coupled to the RF module 51, converts the baseband signals to a bit stream. The MAC module 55, coupled to the baseband module 53, processes the bit stream to obtain data packets. The processor 57, coupled to the MAC module 55, receives the data packets and conducts networking operations. The processor 57 also carries out the power saving mode operation. When the station 50 enters a power saving mode, beacon frames received by the station 50 are parsed by processor 57.

For example, according to the power saving mode specified in the IEEE 802.11 standard, the station informs the access point it's going to enter power saving mode by transmitting a frame with power saving bit on. In power saving mode, the station can switch its state between doze state and awake state. In doze state, the station can shutdown its the RF module 51, baseband module 53, and MAC module 55 to reduce power consumption. Meanwhile, the processor 57 then switches to a slow clock to continue time calculation. The access point buffers directed frames toward a station in power saving mode and only transmits broadcast and multicast frames in DTIM. The periodically transmitted beacon frame comprises a TIM field indicating whether there are queued packets for a particular station. At expected beacon's arrival time, the processor 57 wakes the RF module 51, baseband module 53, and MAC module 55 to receive a beacon frame, and parses the beacon frame for further operation. The processor 57 determines whether the DTIM count in the received beacon is 0. If the DTIM count is not 0, the subsequent wake-up time is adjusted according to the DTIM count. Generally, the next time the processor 57 will wake up at a time corresponding to the beacon frame specifying a DTIM count of 0.

FIG. 5 illustrates a schematic diagram of a third embodiment of a station. A station 60 comprises a radio frequency (RF) module 61, a baseband module 63, a media access control (MAC) module 65, host interface 68, and a central processing unit (CPU) 69. The RF module 61 demodulates received radio signals to generate baseband signals. The baseband module 63, coupled to the RF module 61, converts the baseband signals to a bit stream. The MAC module 65, coupled to the baseband module 63, processes the bit stream to obtain data packets. The CPU 69, coupled to the MAC module 65 via the host interface 68, receives the data packets and conducts networking operations. The CPU 69 also carries out the power saving mode operation. When the station 60 enters a power saving mode, beacon frames received by the station 60 are parsed by CPU 69.

For example, according to the power saving mode specified in the IEEE 802.11 standard, the station informs the access point it's going to enter power saving mode by transmitting a frame with power saving bit on. In power saving mode, the station can switch its state between doze state and awake state. In doze state, the station can shutdown its the RF module 61, baseband module 63, MAC module 65 to reduce power consumption. The CPU 69 may switch to a slow clock to continue time calculation. The CPU 69 performs general operation of the station 60, as well as operations implemented in a power saving mode, such as beacon frame parsing. The access point buffers directed frames toward a station in power saving mode and only transmits broadcast and multicast frames in DTIM. The periodically transmitted beacon frame comprises a TIM field indicating whether there are queued packets for a particular station. At expected beacon's arrival time, the CPU 69 wakes the RF module 61, baseband module 63, and MAC module 65 to receive a beacon frame, and parses the beacon frame for further operation. The CPU 69 determines whether the DTIM count in the received beacon is 0. If the DTIM count is not 0, the subsequent wake-up time is adjusted according to the DTIM count. Generally, the next time the CPU 69 would wake up at a time corresponding to a beacon frame specifying a DTIM count of 0.

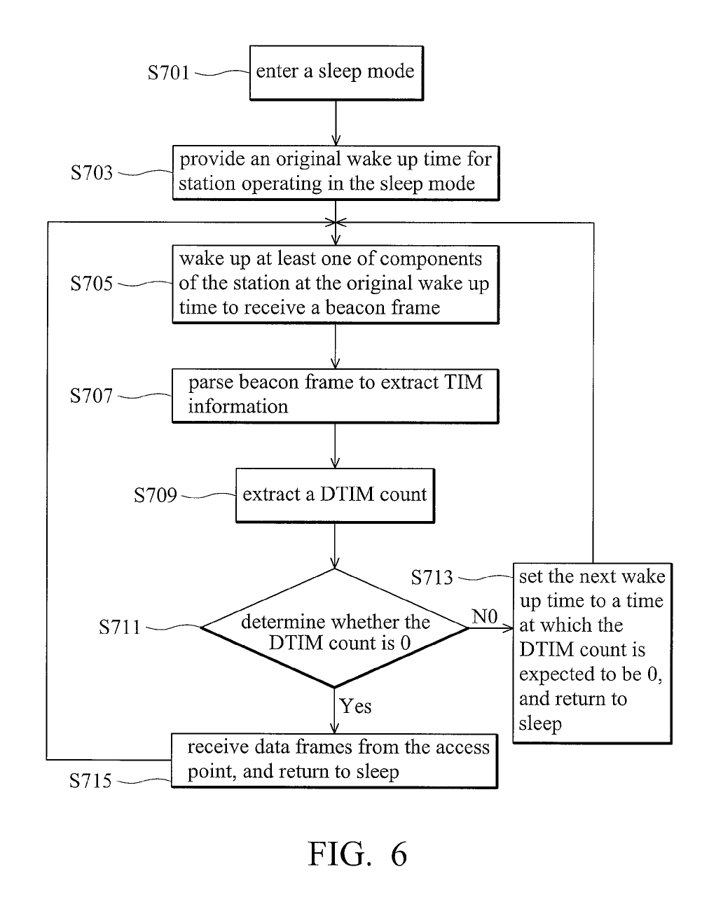

For FIG. 6, in step S701, a station enters into a sleep mode. In step S703, an original wake-up time is provided for the station operating in the sleep mode. In step S705, at least one of components of the station wakes up at the original wake-up time to receive a beacon frame from the access point. In step S707, the beacon frame is parsed to extract traffic indication map (TIM) information specified therein. In step S709, a delivery TIM (DTIM) count is extracted from the TIM information. In step S711, it is determined whether the DTIM count is C, and if so, the method proceeds to step S715, otherwise, to step S713. In step S713, the next wake-up time is set to a time at which the DTIM count is expected to be 0, and the station returns to sleep. In step S715, buffered broadcast/multicast frames are received, and the station returns to sleep.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of controlling a station connecting to an access point of a wireless local area network (WLAN), comprising:
causing the station to enter a sleep mode;
providing an original wake-up time for the station operating in the sleep mode;
waking up at least one of the components of the station at the original wake-up time to receive a beacon frame from the access point;
parsing the beacon frame to extract traffic indication map (TIM) information specified therein; and
determining a next wake-up time by adjusting the original wake-up time according to the TIM information.

2. The method of claim 1, further comprising:
extracting a delivery TIM (DTIM) count from the TIM information;
determining whether the DTIM count is 0; and
when the DTIM count is not 0, setting the next wake-up time to a time at which the DTIM count is expected to be 0.

3. The method of claim 1, wherein the method is implemented by an application specific integrated circuit (ASIC).

4. The method of claim 3, further causing a radio frequency (RF) module, a baseband module, a media access control (MAC) module, and a processor of the station into the sleep mode, and waking up the RF module, the baseband module, the MAC module at the original wake-up time to receive the beacon frame.

5. The method of claim 4, further determining, according to the TIM information, whether frames directed toward the station are buffered in the access point, and if so, waking up the processor to receive the frames from the access point.

6. The method of claim 1, wherein the method is implemented by a general purpose processor of the station.

7. The method of claim 6, further causing a radio frequency (RF) module, a baseband module, and a media access control (MAC) module of the station into the sleep mode, and waking up the RF module, the baseband module, the MAC module at the wake-up time to receive the beacon frame.

8. The method of claim 6, further determining, according to the TIM information, whether frames directed to the station are buffered in the access point, and if so, receiving the frames from the access point.

9. The method of claim 1, further causing the station to return to the sleep mode and waking up the station at the next wake-up time.

10. A method of controlling a station connecting to an access point of a wireless local area network (WLAN), wherein the method is implemented by an application specific integrated circuit (ASIC) in the station, the method comprising:
causing the station to enter a sleep mode;
providing an original wake-up time for the station operating in the sleep mode;
waking up at least one of the components of the station at the original wake-up time to receive a beacon frame from the access point;
parsing the beacon frame to extract traffic indication map (TIM) information specified therein; and
determining a next wake-up time by adjusting the original wake-up time according to the TIM information.

11. The method of claim 10, further comprising:
extracting a delivery TIM (DTIM) count from the TIM information;
determining whether the DTIM count is 0; and
when the DTIM count is not 0, setting the next wake-up time to a time at which the DTIM count is expected to be 0.

12. The method of claim 10, further causing a radio frequency (RF) module, a baseband module, a media access control (MAC) module, and a processor of the station into the sleep mode, and waking up the RF module, the baseband module, the MAC module at the wake-up time to receive the beacon frame.

13. The method of claim 12, further determining, according to the TIM information, whether frames directed to the station are buffered in the access point, and if so, waking up the processor to receive the frames from the access point.

14. The method of claim 10, further causing the station to return to the sleep mode and waking up the station at the next wake-up time.

15. A station connecting to an access point of a wireless local area network (WLAN), comprising:
a communication unit receiving beacon frames from the access point;
a beacon parser parsing the beacon frames to extract traffic indication map (TIM) information specified therein; and
a processing unit determining, according to the TIM information, a next wake-up time by adjusting a preset original wake-up time for the station operating in the sleep mode.

16. The station of claim 15, wherein the processing unit causes the station to enter a sleep mode, and wakes up at least one of the components of the station at the original wake-up time to receive a beacon frame from the access point.

17. The station of claim 15, wherein the beacon parser further extracts a delivery TIM (DTIM) count from the TIM information, and the processing unit further determines whether the DTIM count is 0, and when the DTIM count is not 0, sets the next wake-up time to a time at which the DTIM count is expected to be 0.

18. The station of claim 15, wherein the processing unit and the beacon parser are implemented by an application specific integrated circuit (ASIC).

19. The station of claim 18, the ASIC further causes a radio frequency (RF) module, a baseband module, a media access control (MAC) module, and a processor of the station into the sleep mode, and wakes up the RF module, the baseband module, the MAC module at the original wake-up time to receive the beacon frame.

20. The station of claim 18, wherein the ASIC further determines, according to the TIM information, whether frames directed to the station are buffered in the access point, and if so, wakes up the processor to receive the frames from the access point.

21. The station of claim 15, wherein the processing unit and the beacon parser are implemented by a general purpose processor of the station.

22. The station of claim 21, wherein the processor further causes a radio frequency (RF) module, a baseband module, and a media access control (MAC) module of the station into the sleep mode, and wakes up the RF module, the baseband module, the MAC module at the wake-up time to receive the beacon frame.

23. The station of claim 21, wherein the processor further determines, according to the TIM information, whether frames directed to the station are buffered in the access point, and if so, receives the frames from the access point.

24. The station of claim 15, wherein the processing unit further causing the station to enter the sleep mode and waking up the station at the next wake-up time.

25. A station connecting to an access point of a wireless local area network (WLAN), comprising:
a radio frequency (RF) module, demodulating received radio signals into baseband signals;
a baseband module, coupled to the RF module, converting the baseband signals to a bit stream;
a media access control (MAC) module, coupled to the baseband module, processing the bit stream to obtain data packets;
an application specific integrated circuit (ASIC), coupled to the baseband module, and MAC module, causing the station to enter a sleep mode, waking up at least one of components of the station at a preset original wake-up time to receive a beacon frame from the access point, parsing the beacon frame to extract traffic indication map (TIM) information specified therein, and determining a next wake-up time by adjusting the original wake-up time according to the TIM information.

26. The station of claim 25, wherein the ASIC further extracts a delivery TIM (DTIM) count from the TIM information, determines whether the DTIM count is 0, when the DTIM count is not 0, sets the next wake-up time to a time at which the DTIM count is expected to be 0.

27. The station of claim 25, further comprising a processor, coupled to the MAC module, receiving the data packets to perform networking operations.

28. The station of claim 25, wherein the ASIC further causes the radio frequency (RF) module, the baseband module, the media access control (MAC) module, and the processor of the station into the sleep mode, and wakes up the RF module, the baseband module, the MAC module at the wake-up time to receive the beacon frame.

29. The station of claim 25, wherein the ASIC further determines, according to the TIM information, whether frames directed to the station are buffered in the access point, and if so, wakes up the processor to receive the frames from the access point.

30. The station of claim 25, wherein the ASIC further causes the station to enter the sleep mode and waking up the station at the next wake-up time.
